(19) United States
(12) Patent Application Publication
(10) Pub. No.: US 2012/0127203 A1
(43) Pub. Date: May 24, 2012

(54) MIXED REALITY DISPLAY

(75) Inventor: Francisco IMAI, Mountain View, CA (US)

(73) Assignee: CANON KABUSHIKI KAISHA, Tokyo (JP)

(21) Appl. No.: 13/299,115

(22) Filed: Nov. 17, 2011

Related U.S. Application Data
(63) Continuation-in-part of application No. 12/949,620, filed on Nov. 18, 2010.

(51) Int. Cl. G09G 5/00

(52) U.S. Cl. 345/633

(57) ABSTRACT

An image processing device includes capture optics for capturing light-field information for a scene, and a display unit for providing a display of the scene to a viewer. A tracking unit tracks relative positions of a viewer's head and the display and the viewer's gaze to adjust the display based on the relative positions and to determine a region of interest on the display. A virtual tag location unit determines locations to place one or more virtual tags on the region of interest, by using computational photography of the captured light-field information to determine depth information of an object in the region of interest. A mixed-reality display is produced by combining display of the virtual tags with the display of objects in the scene.

### FIELD

The present disclosure relates to a mixed reality display, and more particularly relates to a mixed reality display which displays computer-generated virtual data for physical objects in a scene.

### BACKGROUND

In the field of mixed reality display, it is common to display computer-generated virtual data over a display of physical objects in a scene. For example, a “heads-up” display in an automobile may present information such as speed over the user's view of the road. In another recent example, an application may display information about constellations viewed through a camera on the user's phone. By providing such virtual tags, it is ordinarily possible to provide information about objects viewed by the user.

In one example, an object is identified using conventional methods such as position sensors, and virtual information corresponding to the identified object is retrieved and added to the display.

### SUMMARY

One problem with conventional mixed reality systems is that the systems are not robust to changing scenes and objects. In particular, while conventional imaging methods may in some cases be able to quickly identify a static object in a simple landscape, they generally are insufficient at quickly identifying objects at changing distances or positions. Because conventional methods are insufficient and/or sluggish at identifying such objects, the device may be unable to tag objects in a scene, particularly when a user changes his viewpoint of the scene by moving.

The foregoing situations are addressed by capturing light-field information of a scene to identify different objects in the scene. Light-field information differs from simple image data in that simple image data is merely a two-dimensional representation of the total amount of light at each pixel of an image, whereas light-field information also includes information concerning the directional lighting distribution at each pixel. Using light-field information, synthetic images can be constructed computationally, at different focus positions and from different viewpoints. Moreover, it is ordinarily possible to identify multiple objects at different positions more accurately, often from a single capture operation.

Thus, in an example embodiment described herein, an image processing device includes capture optics for capturing light-field information for a scene, and a display unit for providing a display of the scene to a viewer. A tracking unit tracks relative positions of a viewer's head and the display and the viewer's gaze to adjust the display based on the relative positions and to determine a region of interest on the display. A virtual tag location unit determines locations to place one or more virtual tags on the region of interest, by using computational photography of the captured light-field information to determine depth information of an object in the region of interest. A mixed-reality display is produced by combining display of the virtual tags with the display of the objects in the scene.

By using light-field information to identify objects in a scene, it is ordinarily possible to provide more robust identification of objects at different distances or positions, and thereby to improve virtual tagging of such objects.

This brief summary has been provided so that the nature of this disclosure may be understood quickly. A more complete understanding can be obtained by reference to the following detailed description and to the attached drawings.

### BRIEF DESCRIPTION OF THE DRAWINGS

FIG. 1 is a representative view of computing equipment relevant to one example embodiment.

FIG. 2 is a detailed block diagram depicting the internal architecture of the host computer shown in FIG. 1.

FIG. 3 is a representational view of an image processing module according to an example embodiment.

FIG. 4 is a flow diagram for explaining presentation of a mixed reality display according to an example embodiment.

FIGS. 5A to 5C are representative views of a mixed reality display according to example embodiments.

### DETAILED DESCRIPTION

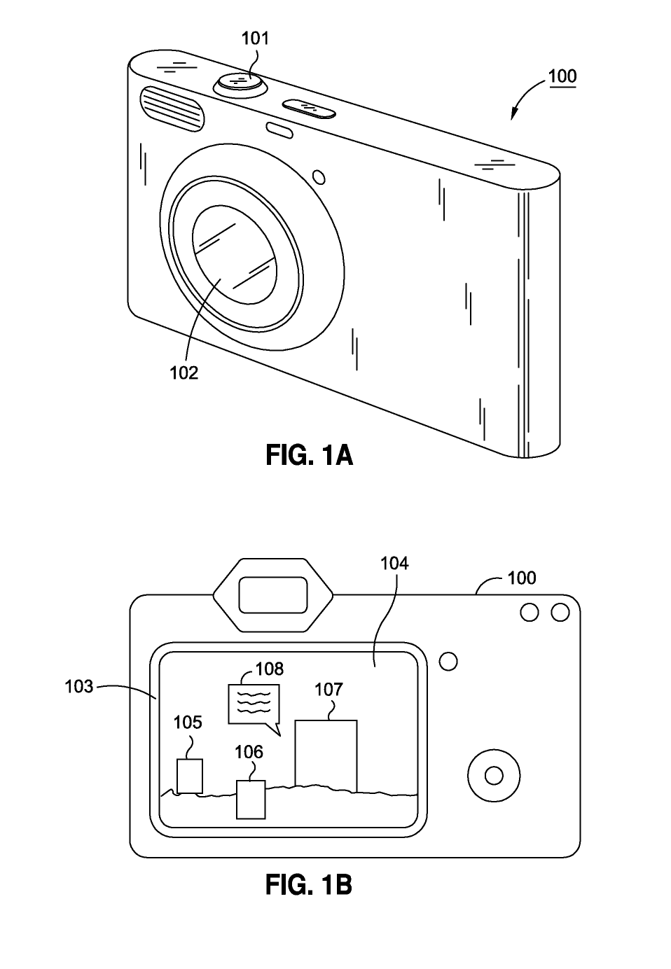

FIGS. 1A and 1B are representative views for explaining the exterior appearance of an image capture device relevant to one example embodiment. In these figures, some components are omitted for conciseness. As shown in FIGS. 1A and 1B, image capture device 100 is constructed as an embedded and hand held device including a variety of user interfaces for permitting a user to interact therewith, such as shutter button 101. Imaging unit 102 operates in conjunction with an imaging lens, a shutter, an image sensor and a light-field information gathering unit to act as a light-field gathering assembly which gathers light-field information of a scene in a single capture operation, as described more fully below. Image capture device 100 may connect to other devices via wired and/or wireless interfaces (not shown).

Image capture device 100 further includes an image display unit 103 for displaying menus, thumbnail images, and a preview image. The image display unit 103 may be a liquid crystal screen.

As shown in FIG. 1B, image display unit 103 displays a scene 104 as a preview of an image to be captured by the image capture device. The scene 104 includes a series of physical objects 105, 106 and 107. As also shown in FIG. 1B, the physical object 107 is tagged with a floating virtual tag 108 describing information about the object. This process will be discussed in more detail below.

While FIGS. 1A and 1B depict one example embodiment of image capture device 100, it should be understood that the image capture device 100 may be configured in the form of, for example, a cellular telephone, a pager, a radio telephone, a personal digital assistant (PDA), or a Moving Pictures Expert Group Layer 3 (MP3) player, or larger embodiments such as a standalone imaging unit connected to a computer monitor, among many others.

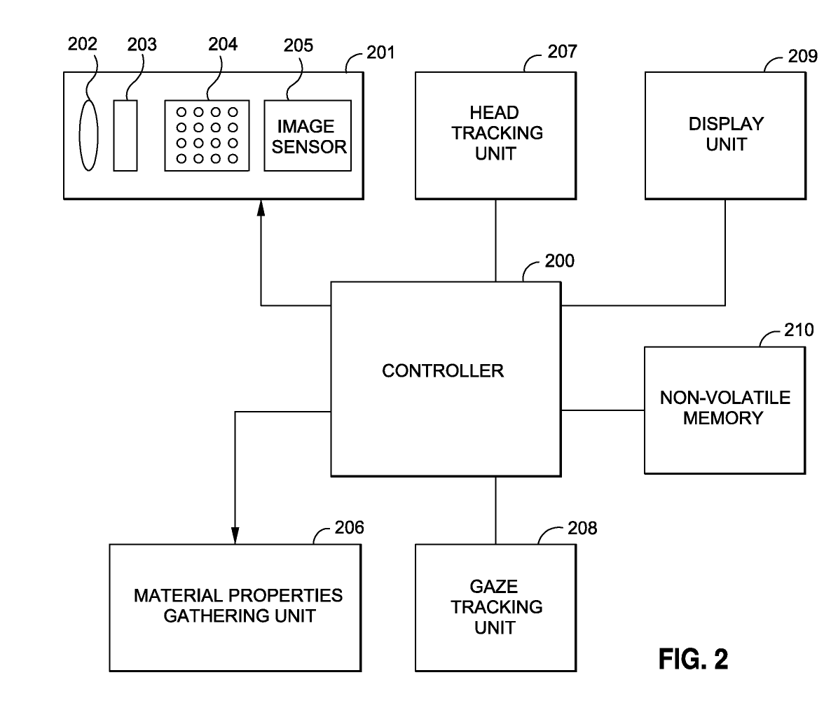

FIG. 2 is a block diagram for explaining the internal architecture of the image capture device 100 shown in FIG. 1 according to one example embodiment.

As shown in FIG. 2, image capture device 100 includes controller 200, which controls the entire image capture device 100. The controller 200 executes programs recorded in nonvolatile memory 210 to implement respective processes to be described later. For example, controller 200 may obtain material properties of objects at different depths in a displayed scene, and determine where to place virtual tags.

Capture optics for image capture device 100 comprise light field gathering assembly 201, which includes imaging lens 202, shutter 203, light-field gathering unit 204 and image sensor 205.

More specifically, reference numeral 202 denotes an imaging lens; 203, a shutter having an aperture function; 204, a light-field gathering unit for gathering light-field information; and 205, an image sensor, which converts an optical image into an electrical signal. A shield or barrier may cover the light field gathering assembly 201 to prevent an image capturing system including imaging lens 202, shutter 203, light-field gathering unit 204 and image sensor 205 from being contaminated or damaged.

In the present embodiment, imaging lens 202, shutter 203, light-field gathering unit 204 and image sensor 205 function together to act as light-field gathering assembly 201 which gathers light-field information of a scene in a single capture operation.

Imaging lens 202 may be of a zoom lens, thereby providing an optical zoom function. The optical zoom function is realized by driving a magnification-variable lens of the imaging lens 202 using a driving mechanism of the imaging lens 202 or a driving mechanism provided on the main unit of the image capture device 100.

Light-field information gathering unit 204 captures light-field information. Examples of such units include multi-aperture optics, polydioptric optics, and a plenoptic system. Light-field information differs from simple image data in that image data is merely a two-dimensional representation of the total amount of light at each pixel of an image, whereas light-field information also includes information concerning the directional lighting distribution at each pixel. In some usages, light-field information is sometimes referred to as four-dimensional. In one embodiment, the image data for the scene is stored in non-volatile memory 210 without also storing the light-field information of the scene in the non-volatile memory 210. In particular, in such an example embodiment, the image capture device may store the light-field information in terms of larger blocks such as “super-pixels” comprising one or more pixels, in order to reduce the overall amount of image data for processing.

Image sensor 205 converts optical signals to electrical signals. In particular, image sensor 205 may convert optical signals obtained through the imaging lens 202 into analog signals, which may then be output to an A/D converter (not shown) for conversion to digital image data. Examples of image sensors include a charge-coupled device (CCD) or a complementary metal-oxide-semiconductor (CMOS) active-pixel sensor, although numerous other types of image sensors are possible.

A light beam (light beam incident upon the angle of view of the lens) from an object that goes through the imaging lens (image sensing lens) 202 passes through an opening of the shutter 203 having a diaphragm function, into light-field information gathering unit 204, and forms an optical image of the object on the image sensing surface of the image sensor 205. The image sensor 205 and is controlled by clock signals and control signals provided by a timing generator which is controlled by controller 200.

As mentioned above, light-field gathering assembly 201 gathers light-field information of a scene in a single capture operation. The light field information allows for improved estimation of objects at different depths, positions, and foci, and can thereby improve identification of objects.

For example, a computer interpreting simple image data might conclude that two objects at different depths are actually the same object, because the outline of the objects overlap. In contrast, the additional information in light-field information allows the computer to determine that these are two different objects at different depths and at different positions, and may further allow for focusing in on either object. Thus, the light-field information may allow for an improved determination of objects at different distances, depths, and/or foci in the scene. Moreover, the improved identification of objects may also allow for better placement of virtual tags, e.g., identifying “open” spaces between objects so as not to obscure the objects.

As also shown in FIG. 2, image capture device 100 further includes material properties gathering unit 206, head tracking unit 207, gaze tracking unit 208, display unit 209 and non-volatile memory 210.

Material properties gathering unit 206 gathers information about properties of materials making up the objects shown in the scene on display unit 209, such as objects whose image is to be captured by image capture device 100. Material properties gathering unit 206 may improve on a simple system which bases identification simply on captured light. For example, material properties gathering unit 206 may obtain additional color signals, to provide the spectral signature of objects in the scene. Additionally, relatively complex procedures can be used to reconstruct more color channels from original data. Other sensors and information could be used to determine the material properties of objects in the scene, but for purposes of conciseness will not be described herein. The information gathered by material properties gathering unit 206 allows image capture device to identify objects in the scene, and thereby to select appropriate virtual data for tagging such objects, as described more fully below. Material properties gathering unit 206 does not necessarily require information from light-field gathering assembly 201, and thus can operate independently thereof.

Head tracking unit 207 tracks relative positions of the viewer's head and display unit 209 on image capture device 100. This information is then used to re-render a display on display unit 209, such as a preview display, more robustly. In that regard, by tracking certain features of the viewer's head (eyes, mouth, etc.) and adjusting the rendered display to correspond to these movements, the image capture device can provide the viewer with multiple perspectives on the scene, including 3-D perspectives. Thus, the viewer can be provided with a “virtual camera” on the scene with its own coordinates. For example, if head tracking unit detects that the viewer's head is above the camera, the display may be re-rendered to show a 3-D perspective above the perspective which would actually be captured in an image capture operation. Such perspectives may be useful to the viewer in narrowing down which physical objects the viewer wishes to obtain virtual data about. An example method for such head tracking is described in U.S. application Ser. No. 12/776,842, filed May 10, 2010, titled “Adjustment of Imaging Property in View-Dependent Rendering”, by Francisco Imai, the contents of which are incorporated herein by reference.

Gaze tracking unit 208 tracks the location of the viewer's gaze on the display of display unit 209. Gaze tracking is sometimes also referred to as eye tracking, as the process tracks what the viewer's eyes are doing, even if the viewer's head is static. Numerous methods of gaze tracking have been devised and are described in, for example, the aforementioned U.S. application Ser. No. 12/776,842, but for purposes of conciseness will not be described here in further detail. In some embodiments, gaze tracking may be performed based on the location of the viewer's viewfinder, which may or may not be different from the location of display unit 209. By tracking the viewer's gaze, it is ordinarily possible to identify a region of interest in the display. Identifying a region of interest allows for more precise placement of virtual tags, as described more fully herein.

In this embodiment, head tracking unit 207 and gaze tracking unit 208 are described above as separate units. However, these units could be combined into a single tracking unit for tracking relative positions of a viewer's head and the display and the viewer's gaze to adjust the display based on the relative positions and to determine a region of interest on the display.

Display unit 209 is constructed to display menus, thumbnail images, and a preview image. Display unit 209 may be a liquid crystal screen, although numerous other display hardware could be used depending on environment and use.

A nonvolatile memory 210 is a non-transitory electrically erasable and recordable memory, and uses, for example, an EEPROM. The nonvolatile memory 210 stores constants, computer-executable programs, and the like for operation of controller 200. In particular, non-volatile memory 210 is an example of a non-transitory computer-readable storage medium, having stored thereon image processing module 300 as described below.

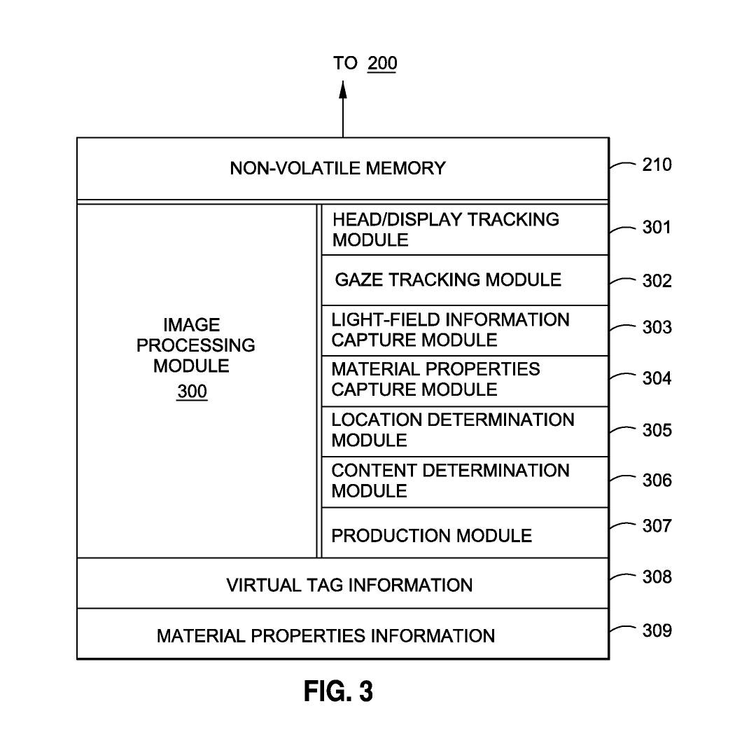

FIG. 3 is a representative view of an image processing module according to an example embodiment.

According to this example embodiment, image processing module 300 includes head/display tracking module 301, gaze tracking module 302, light-field information capture module 303, material properties capture module 304, location determination module 305, content determination module 306 and production module 307.

Specifically, FIG. 3 illustrates an example of image processing module 300 in which the sub-modules of image processing module 300 are included in non-volatile memory 210. Each of the sub-modules are computer-executable software code or process steps executable by a processor, such as controller 200, and are stored on a computer-readable storage medium, such as non-volatile memory 210, or on a fixed disk or RAM (not shown). More or less modules may be used, and other architectures are possible.

As shown in FIG. 3, image processing module includes head/display tracking module 301 for tracking relative positions of a viewer's head and the display, and adjusting the display based on the relative positions. Gaze tracking module 302 is for tracking the viewer's gaze, to determine a region of interest on the display. Light-field information capture module 303 captures light-field information of the scene using capture optics (such as light field gathering assembly 201). Material property capturing module 304 captures a material property of one or more objects in the scene. Location determination module 305 determines locations to place one or more virtual tags on the region of interest, by using computational photography of the captured light-field information to determine depth information of an object in the region of interest, and content determination module 306 determines the content of the virtual tags, based on the captured material properties. Production module 307 produces a mixed-reality display by combining display of the virtual tags with the display of the objects in the scene.

Additionally, as shown in FIG. 3, non-volatile memory 210 also stores virtual tag information 308. Virtual tag information 308 may include information describing physical objects, to be included in virtual tags added to the display as described below. For example, virtual tag information 308 could store information describing an exhibit in a museum which is viewed by the viewer. Virtual tag information 308 may also store information regarding the display of the virtual tag, such as the shape of the virtual tag.

Non-volatile memory 201 may additionally store material properties information 309, which includes information indicating a correspondence between properties obtained by material properties gathering unit 206 and corresponding objects, for use in identifying the objects. For example, material properties information 309 may be a database storing correspondences between different spectral signatures and the physical objects which match those spectral signatures. The correspondence is used to identify physical objects viewed by the viewer through image capture device 100, which is then used to obtain virtual tag information from virtual tag information 308 corresponding to the physical objects.

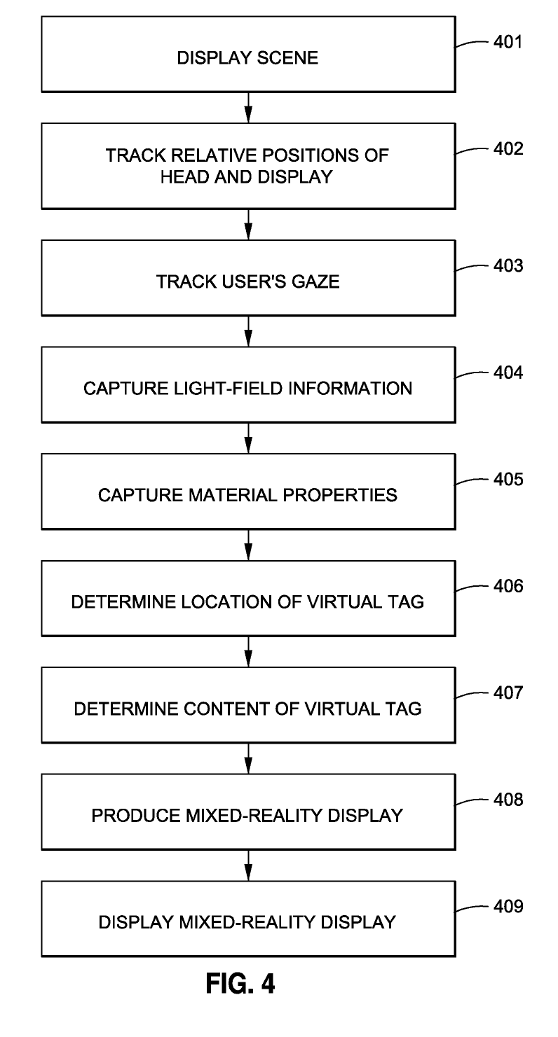

FIG. 4 is a flow diagram for explaining processing in the image capture device shown in FIG. 1 according to an example embodiment.

Briefly, in FIG. 4, image processing is performed in an image capture device comprising capture optics for capturing light-field information for a scene and a display unit for providing a display of the scene. A display of the scene is provided to a viewer. Relative positions of a viewer's head and the display and the viewer's gaze are tracked, to adjust the display based on the relative positions and to determine a region of interest on the display. There is a determination of locations to place one or more virtual tags on the region of interest, by using computational photography of the captured light-field information to determine depth information of an object in the region of interest. A mixed-reality display is produced by combining display of the virtual tags with the display of the objects in the scene.

In more detail, in step 401, a scene is displayed to the viewer. For example, a display unit on the image capture device may display a preview of an image to be captured by the image capture unit. In that regard, the scene may be partially or wholly computer-generated to reflect additional perspectives for the viewer, as discussed above.

In step 402, relative positions of the viewer's head and the display are tracked. In particular, positional coordinates of the viewer's head and the display are obtained using sensors or other techniques, and a relative position is determined. As discussed above, the relative positions are then used to re-render the display, such as a preview display, more robustly. In that regard, by tracking certain features of the viewer's head (eyes, mouth, etc.) and re-rendering the display to correspond to these movements, the image capture device can provide the viewer with multiple perspectives on the scene, including 3-D perspectives. Specifically, in one embodiment, the display is a computer-generated display which provides a three-dimensional perspective of the scene, and the perspective is adjusted according to the relative positions of the viewer's head and the display.

For example, if head/display tracking unit detects that the viewer's head is above the camera, the display may be re-rendered to show a 3-D perspective above the perspective which would actually be captured in an image capture operation. Such perspectives may be useful to the viewer in narrowing down which physical objects the viewer wishes to obtain virtual data about.

In step 403, the viewer's gaze is tracked. In particular, gaze tracking systems such as pupil tracking are used to determine which part of the display the viewer is looking at, in order to identify a region of interest in the display. The region of interest can be used to narrow the amount of physical objects which are to be tagged with virtual tags, making the display more viewable to the viewer. In that regard, if the display simply included the entire scene and the scene includes a large number of tagged physical objects, the number of virtual tags could be overwhelming to the viewer, or there might not be room to place all of the virtual tags in a viewable manner

In some embodiments, the gaze may be tracked using sensors in a viewfinder of an image capture device, which may or may not correspond to the location of the display unit of the image capture device. The placement and use of sensors and other hardware for tracking the gaze may also depend on the particular embodiment of the image capture device. For example, different hardware may be needed to track a gaze on the smaller display of a cellular telephone, as opposed to a larger display unit or monitor screen.

In step 404, light-field information is captured. Examples of capture optics for capturing such light-field information include multi-aperture optics, polydioptric optics, or a plenoptic system. The light-field information of the scene may be obtained in a single capture operation. The capture may also be ongoing.

By capturing light-field information instead of simple image data, it may be possible improve the accuracy of identifying physical objects, as the additional image information allows more objects at different depths and distances to be detected more clearly, and with different foci, as discussed above. In addition, the light field information can be used to improve a determination of where virtual tags for such physical objects should be placed, based on the depth of the physical object to be identified and the depths of other objects in the scene.

In one example, the light-field information can be used to generate synthesized images where different objects are in focus, all from the same single capture operation. Moreover, objects in the same range from the device (not shown) can have different focuses. Thus, multiple different focuses can be obtained using the light-field information, and can be used in identification of objects, selection of a region of interest and/or determining locations of virtual tags.

In step 405, material properties of objects in the scene are captured. In one example, spectral signatures of objects in the scene are obtained. Specifically, spectral imaging systems, having more spectral bands than the human eye, enable recognition of the ground-truth of the materials by identifying the spectral fingerprint that is unique to each material.

Of course, other methods besides spectral signatures may be used to identify objects in the scene. For example, for some objects, Global Positioning System (GPS) data may help in identifying an object such as a landmark. In another example, geo-location sensors such as accelerometers could be used. Numerous other methods are possible.

In step 406, the location of one or more virtual tags is determined, based on depth information of the objects generated from the captured light-field information.

In particular, using the light-field information, the image capture device can more clearly determine objects at different depths, and thus better approximate appropriate coordinates for where to place virtual tags.

For example, using the depth information of captured by the light-field optics, a 3-D model of the scene can be generated. This 3-D model can be further refined according to the viewer's perspective (e.g., above or below horizontal), using the relative positions of the head and display tracked in step 402. Moreover, the area in which to apply the virtual tags can be narrowed to a region of interest, using information from the gaze tracking in step 403.

Positional coordinates of the virtual tags can then be determined according to different display placement procedures, which for purposes of conciseness are not described herein. In that regard, the placement of the virtual tags may be translated and/or rotated according to changes in the perspective shown in display. For example, if the viewer moves his/her head or changes gaze, the virtual tags may be moved, rotated, or translated in accordance with such changes. Thus, the location of the virtual tags changes in relation to changes in the display and the viewer's gaze.

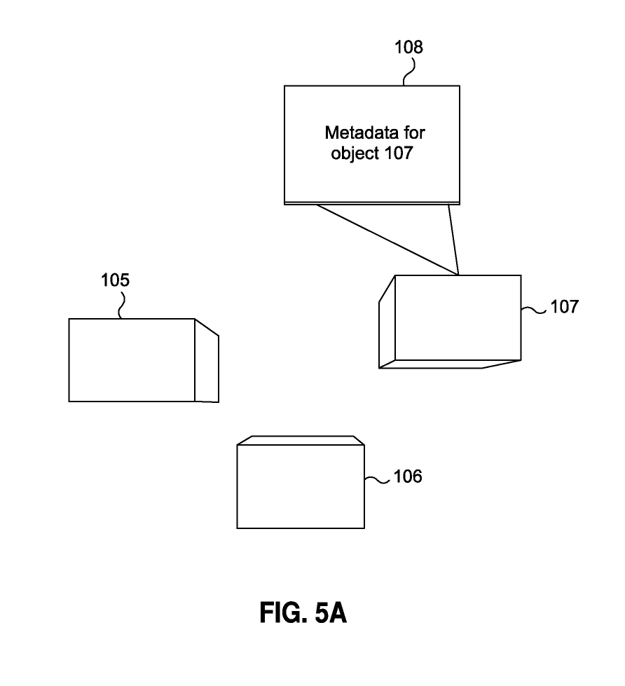

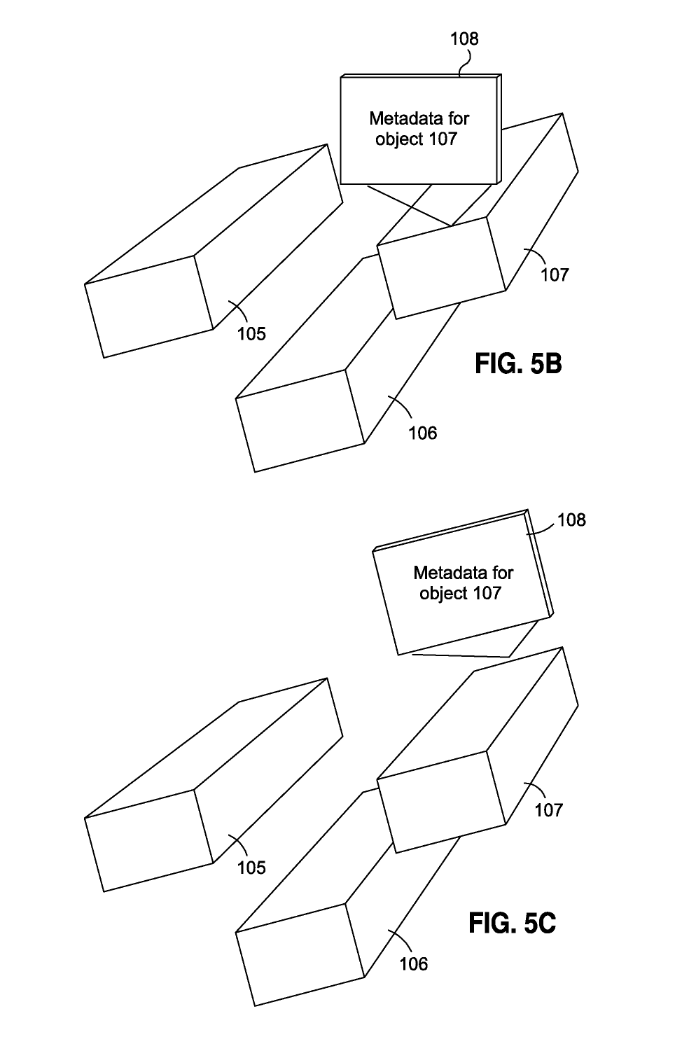

In one example, positions or coordinates for virtual tags are determined for objects at a similar depth in the region of interest. In particular, narrowing the possible locations to objects at the similar depths further segments the region of interest, providing a more specific and straightforward display to the viewer. In that regard, FIG. 5A shows a top view of the objects 105, 106 and 107 corresponding to the objects shown in a front view in FIG. 1B. It is clear in FIG. 5A that object 106 is closer to the camera while object 107 is further away and object 105 is in between objects 106 and 107 in terms of distance from the camera. Each object 105, 106 and 107 has a different depth.

Limiting the virtual tags to objects at the similar depths may help reduce the occurrence of situations in which virtual tags for objects at different depths overlap or obscure each other. For example, in FIG. 5B, the viewer has changed the viewing perspective drastically and the virtual tag 108 with the metadata on object 107 seems awkwardly out of place since it did not change perspective as well.

Thus, in combination with the viewer's perspective determined by the head/display tracking unit and the gaze tracking unit, appropriate locations for virtual tags can be determined by applying a proper vanishing point through virtual camera positioning as exemplified in FIG. 5C.

In another example, the virtual tag can be superimposed over part of the image of the physical object, rather than near the physical object. In that regard, the virtual tag could be substantially transparent, to avoid obscuring some of the image of the physical object.

In some situations, it may be useful to limit the number of physical objects which are to be virtually tagged. For example, tagging every object in a scene might strain resources, and may not be useful if some objects are relatively unimportant.

In step 407, the content of one or more virtual tags is determined, based on the captured one or more material properties.

As discussed above, spectral signatures of objects in the scene are obtained, and are compared against a database (e.g., material properties information 309) to identify the corresponding object(s), although other methods are possible.

Once the objects in the scene are identified, the content for corresponding virtual tags can be retrieved (e.g., from material properties information 309). For example, for a physical object such as a museum exhibit, the virtual tag data may be text for a word bubble such as that shown in FIG. 1B, in which the text describes characteristics or history of the exhibit.

In step 408, the mixed-reality display is produced. In particular, a display is rendered in which the virtual tags are superimposed on or near the image of the identified physical objects in the region of interest, with the determined content.

In step 409, the mixed-reality display is displayed to the viewer via the display unit.

By using light-field information of the scene to estimate depths of objects in a scene, it is ordinarily possible to provide more robust identification of objects at different distances or positions, and thereby to improve virtual tagging of such objects.

This disclosure has provided a detailed description with respect to particular representative embodiments. It is understood that the scope of the appended claims is not limited to the above-described embodiments and that various changes and modifications may be made without departing from the scope of the claims.

What is claimed is:

1. An image processing device comprising:
capture optics for capturing light-field information for a scene;
a display unit for providing a display of the scene to a viewer;
a tracking unit for tracking relative positions of a viewer's head and the display and the viewer's gaze to adjust the display based on the relative positions and to determine a region of interest on the display;
a virtual tag location unit, for determining locations to place one or more virtual tags on the region of interest, by using computational photography of the captured light-field information to determine depth information of an object in the region of interest;
a production unit for producing a mixed-reality display by combining display of the virtual tags with the display of objects in the scene.

2. The image processing device according to claim 1, further comprising a material property capturing unit for capturing a material property of the object, and a virtual tag content unit for determining the content of the virtual tag for the object, based on the captured material property.

3. The image processing device according to claim 2, wherein the material property of the object is a spectral signature.

4. The image processing device according to claim 1, wherein the virtual tag location unit determines positions for virtual tags for objects at a similar depth in the region of interest.

5. The image processing device according to claim 4, wherein the positions for the virtual tags are determined by applying a vanishing point through virtual camera positioning.

6. The image processing device according to claim 1, wherein the display is a computer-generated display which provides a three-dimensional perspective of the scene, and which is adjusted according to the relative positions of the viewer's head and the display.

7. The image processing device according to claim 1, wherein the image data for the scene is stored in a memory without also storing the light-field information of the scene in the memory.

8. The image processing device according to claim 1, wherein the capture optics comprise multi-aperture optics.

9. The image processing device according to claim 1, wherein the capture optics comprise polydioptric optics.

10. The image processing device according to claim 1, wherein the capture optics comprise a plenoptic system.

11. A method of image processing for an image capture device comprising capture optics for capturing light-field information for a scene and a display unit, comprising:
providing a display of the scene to a viewer on the display unit;
tracking relative positions of a viewer's head and the display and the viewer's gaze to adjust the display based on the relative positions and to determine a region of interest on the display;
determining locations to place one or more virtual tags on the region of interest, by using computational photography of the captured light-field information to determine depth information of an object in the region of interest;
producing a mixed-reality display by combining display of the virtual tags with the display of objects in the scene.

12. The method according to claim 11, further comprising capturing a material property of the object, and determining the content of the virtual tag for the object based on the captured material property.

13. The method according to claim 12, wherein the material property of the object is a spectral signature.

14. The method according to claim 11, wherein the positions for virtual tags are determined for objects at a similar depth in the region of interest.

15. The method according to claim 14, wherein the positions for the virtual tags are determined by applying a vanishing point through virtual camera positioning.

16. The method according to claim 11, wherein the display is a computer-generated display which provides a three-dimensional perspective of the scene, and which is adjusted according to the relative positions of the viewer's head and the display.

17. The method according to claim 11, wherein the image data for the scene is stored in a memory without also storing the light-field information of the scene in the memory.

18. The method according to claim 11, wherein the capture optics comprise multi-aperture optics.

19. The method according to claim 11, wherein the capture optics comprise polydioptric optics.

20. The method according to claim 11, wherein the capture optics comprise a plenoptic system.

21. An image processing module for an image capture device comprising capture optics for capturing light-field information for a scene and a display unit for providing a display of the scene, comprising:
a tracking module for tracking relative positions of a viewer's head and the display and the viewer's gaze to adjust the display based on the relative positions and to determine a region of interest on the display;
a virtual tag location module for determining locations to place one or more virtual tags on the region of interest, by using computational photography of the captured light-field information to determine depth information of an object in the region of interest;
a production module for producing a mixed-reality display by combining display of the virtual tags with the display of objects in the scene.

22. The image processing module according to claim 21, further comprising a material property capturing module for capturing a material property of the object, and a virtual tag content module for determining the content of the virtual tag for the object, based on the captured material property.

23. The image processing module according to claim 22, wherein the material property of the object is a spectral signature.

24. The image processing module according to claim 21, wherein the positions for virtual tags are determined for objects at a similar depth in the region of interest.

25. The image processing module according to claim 24, wherein the positions for the virtual tags are determined by applying a vanishing point through virtual camera positioning.

26. The image processing module according to claim 21, wherein the display is a computer-generated display which provides a three-dimensional perspective of the scene, and which is adjusted according to the relative positions of the viewer's head and the display.

27. The image processing module according to claim 21, wherein the image data for the scene is stored in a memory without also storing the light-field information of the scene in the memory.

28. The image processing module according to claim 21, wherein the capture optics comprise multi-aperture optics.

29. The image processing module according to claim 21, wherein the capture optics comprise polydioptric optics.

30. The image processing module according to claim 21, wherein the capture optics comprise a plenoptic system.

31. A non-transitory computer-readable storage medium retrievably storing computer-executable process steps for performing a method for image processing for an image capture device comprising capture optics for capturing light-field information for a scene and a display unit for providing a display of the scene, the method comprising:
providing a display of the scene to a viewer;
tracking relative positions of a viewer's head and the display and the viewer's gaze to adjust the display based on the relative positions and to determine a region of interest on the display;
determining locations to place one or more virtual tags on the region of interest, by using computational photography of the captured light-field information to determine depth information of an object in the region of interest;
producing a mixed-reality display by combining display of the virtual tags with the display of objects in the scene.

32. The computer-readable storage medium according to claim 31, wherein the method further comprises capturing a material property of the object, and determining the content of the virtual tag for the object based on the captured material property.

33. The computer-readable storage medium according to claim 32, wherein the material property of the object is a spectral signature.

34. The computer-readable storage medium according to claim 31, wherein the positions for virtual tags are determined for objects at a similar depth in the region of interest.

35. The computer-readable storage medium according to claim 34, wherein the positions for the virtual tags are determined by applying a vanishing point through virtual camera positioning.

36. The computer-readable storage medium according to claim 31, wherein the display is a computer-generated display which provides a three-dimensional perspective of the scene, and which is adjusted according to the relative positions of the viewer's head and the display.

37. The computer-readable storage medium according to claim 31, wherein the image data for the scene is stored in a memory without also storing the light-field information of the scene in the memory.

38. The computer-readable storage medium according to claim 31, wherein the capture optics comprise multi-aperture optics.

39. The computer-readable storage medium according to claim 31, wherein the capture optics comprise polydioptric optics.

40. The computer-readable storage medium according to claim 31, wherein the capture optics comprise a plenoptic system.
